(19) United States
(12) Patent Application Publication
(10) Pub. No.: US 2005/0051982 A1
(43) Pub. Date: Mar. 10, 2005

(54) Retractable frame of golf trolley

(76) Inventor: Po Tang Su, Kaohsiung City (TW)

Correspondence Address: Po Tang Su, PO Box 82-144, Taipei, TW

(21) Appl. No.: 10/656,148

(22) Filed: Sep. 8, 2003

(51) Int. Cl. B62B 1/00

(52) U.S. Cl. 280/47.26

(57) ABSTRACT

An improved structure of a frame of a golf trolley is comprised of a retainer, two tubes and a flexible fork; a fixation hole being each provided at the lower edge of the tube; each tube containing an inner tube; a through hole being each provided at the upper edge of the inner tube; a pin being inserted through both of the fixation hole and the through hole to connect the inner tube to the lower edge of the tube; or with the pin removed, the fork being folded in by a hinge provided at the middle section of the fork, and the inner tube being inserted into its respective tube for saving space for storage or packaging purpose.

### BACKGROUND OF THE INVENTION

(a) Technical Field of the Invention

The present invention is related to an improved structure of a frame of a golf trolley, and more particularly, to one that is retractable to save packaging or storage space.

(b) Description of the Prior Art

As illustrated in FIG. 1 of the accompanying drawings, a general golfbag 10 has a closed bottom and an open top and multiple clubs are placed into the golf bag 10 through its open end. To make the golfbag more functional, multiple accessories 11, namely, a handle, casters, carrying belt and/or side bags, are provided on the back and/or both sides of the bag. A frame is fixed to the front side of the golf bag 10 for the golf bag 10 to stand on the ground at a certain inclination depending on the level of the course for easier fetching the club. Whereas the volume of the golfbag 10 is fixed and thus consumes a large space for storage, an improvement is made to the golf bag 10 to allow it foldable to save packing materials, transportation cost, and storage space while permitting easy carrying and storage as illustrated in FIG. 2. However, a frame 12 provided in the front side of the golf bag 10 is made in a height approximately equal to that of the golf bag, and the frame 12 is not retractable for an overall space saving.

### SUMMARY OF THE INVENTION

The primary purpose of the present invention is to provide a retractable frame for a golf bag for spacing saving in the packaging and/or storage of the golf bag.

The foregoing object and summary provide only a brief introduction to the present invention. To fully appreciate these and other objects of the present invention as well as the invention itself, all of which will become apparent to those skilled in the art the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a frame for a golf bag of the prior art.

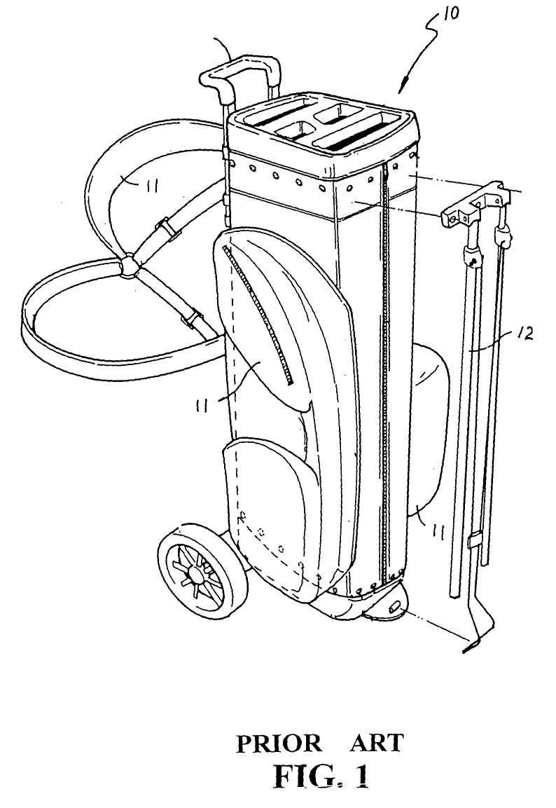

FIG. 2 is a schematic view showing a retractable golfbag of the prior art.

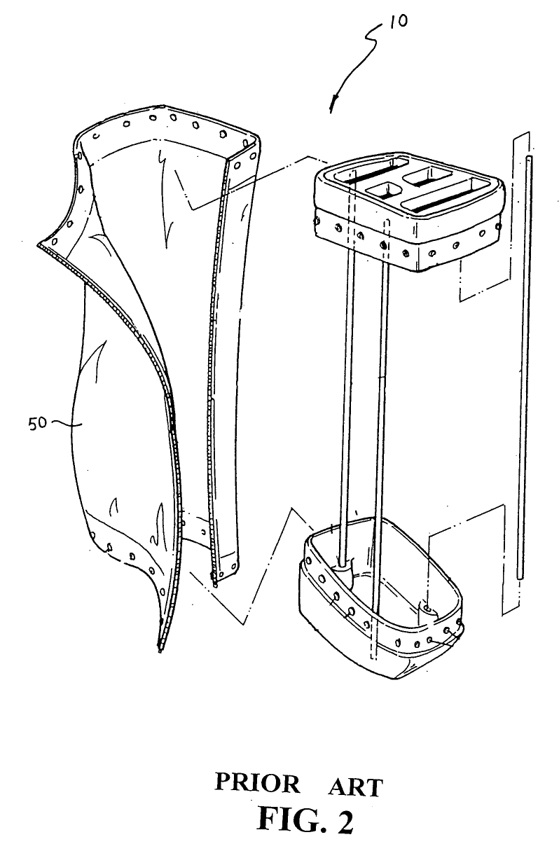

FIG. 3 is a perspective view of a preferred embodiment of the present invention.

FIG. 4 is a sectional view showing an assembly of the preferred embodiment of the present invention.

FIG. 5 is a schematic view showing that the preferred embodiment is retracted.

FIG. 6 is a schematic view showing the preferred embodiment of the present invention in use.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

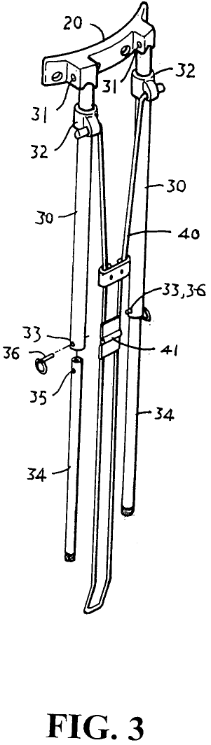

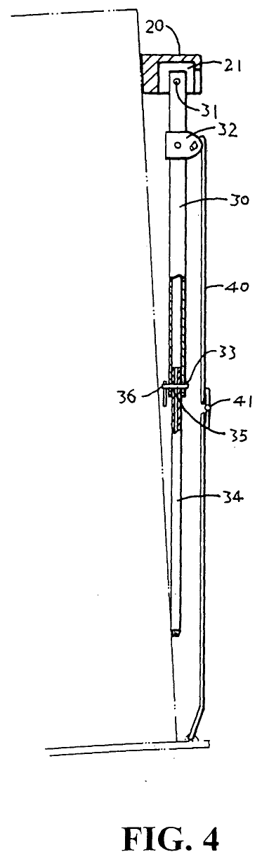

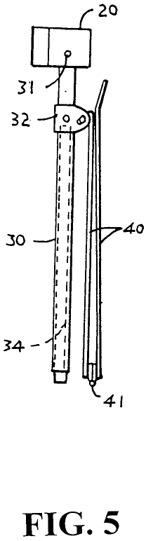

Referring to FIG. 3, a frame of present invention is essentially comprised of a retainer 20, two tubes 30 and a flexible fork 40. Wherein, the retainer 20, also as illustrated in FIGS. 3 and 4 is fixed by means of multiple bolts to the upper edge of the front side of the golfbag while both sides of the retainer 20 is each provided with a recess 21. Both tubes 30 are each pivoted to their respective recess 21 by means of a bolt 31, and each tube 30 swings with the bolt 31 as the axis. A coupling 32 is provided to the upper edge; and a fixation hole 33, the lower edge of the tube 30. Each tube 30 contains an inner tube 34. A through hole 35 is provided at the upper edge of the inner tube 34. When stretched out, the inner tube 34 has its through hole 35 to be aligned with the fixation hole 33 of the tube 30, and a pin 36 is put through both holes 35, 33 for connecting the inner tube 30 to the lower edge of the tube 30. When retracted, the pin 36 is removed for the inner tube 34 to be inserted into the tube 30 as illustrated in FIG. 5. Now referring to FIGS. 3 and 4, a flexible fork 40 is made of a metal rod folded in a Y shape with two branches respectively fixed to their respective coupling 32 at the upper edges of both tubes 30, and the bottom curved flush to be fixed to the upper edge of a base panel of the golf bag. The fork 40 is provided at its middle section with a hinge 41 for the fork 40 to be folded in for storage purpose as illustrated in FIG. 5.

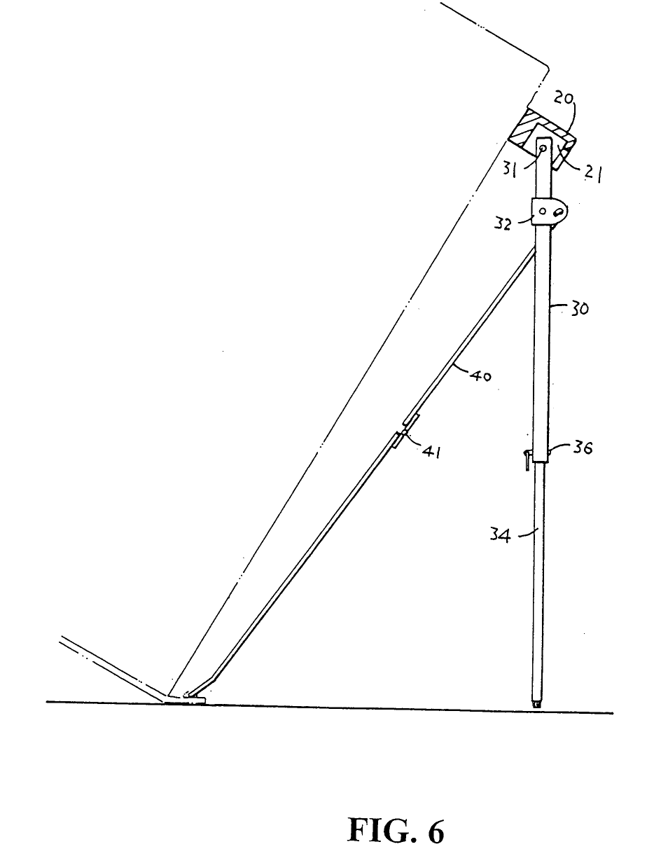

To retract the tubes 30 for storage or packaging, the pin 36 is removed from both of the fixation hole 33 and the through hole 35, the inner tube 34 is inserted into its respective tube 30; then the fork is folded in at the hinge 41 as illustrated in FIG. 5. When used on the golf course, the retainer is bolted to the upper edge of the front side of the golf bag with two tubes 30 respectively fixed to the recesses 21. Both branches of the fork 40 are inserted into and secured to their respective couplings 32 of the tubes 30 while the bottom of the fork 40 is fixed to the upper edge of the base panel of the golf bag. The golf bag inclines towards the tubes 30 and the base panel of the golf bag is curved, and the displacement of the fork 40 causes both tubes 30 to spread up with their terminals to touch the ground to support the golf bag depending on the terrain of the course making it easier for the golfer to fetch a club as desired as illustrated in FIG. 6.

The present invention while supporting the golfbag allows the entire frame to be retracted by inserting the inner tube 34 into the tube 30 and having the fork 40 folded in to save space for storage or packaging.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A retractable frame of a golf trolley comprised of a retainer, two tubes and a flexible fork; the retainer being bolted to the upper edge of the front side of a golf bag, a recess being each provided to both sides of the retainer; each tube being pivoted to its respective recess and capable of swinging with the pivot as the axis; a coupling being provided to the upper edge of each tube; the fork being made of a metal rod curved to indicate a Y shape; both branches of the fork being inserted into and secured to their respective couplings; and the bottom of the fork being fixed to the upper edge of a base panel of the golf bag is characterized by that:
a fixation hole being each provided at the lower edge of the tube;
each tube containing an inner tube; a through hole being provided at the upper edge of the inner tube; the through hole being aligned with the fixation hole; a pin being inserted through both of the fixation hole and the through hole for the inner tube to be connected to the lower edge of the tube; or the pin being removed for the inner tube to be inserted into the tube; a hinge being provided at the mid section of the fork; and the fork being folded in by the hinge.
